(19) United States
(12) Patent Application Publication
(10) Pub. No.: US 2008/0281475 A1
(43) Pub. Date: Nov. 13, 2008

(54) FAN CONTROL SCHEME

(75) Inventors: Tomonori Hirai, Fremont, CA (US); Mario J.D. Lee, Fremont, CA (US)

Correspondence Address: APEX JURIS, PLLC, 12360 LAKE CITY WAY NORTHEAST, SUITE 410, SEATTLE, WA, 98125, US

(73) Assignee: TYAN COMPUTER CORPORATION, Taipei (TW)

(21) Appl. No.: 11/746,346

(22) Filed: May 9, 2007

(51) Int. Cl. G05D 23/00

(52) U.S. Cl. 700/300

(57) ABSTRACT

A fan control architecture is provided for controlling system fan(s) on a computing system that has multiple nodes, a system management network and a fan control module. On each of the nodes a management module is configured to collect system information thereon. In a main fan control scheme, a system management node controls the system fan through the fan control module according to the temperature data sent back from the management module of the other nodes through the system management network. The fan control scheme includes redundant path(s) connected between all the nodes and the fan control module to send high-temperature signals to the fan control module directly. In the case that a threshold high temperature is reached, the fan control module will set the system fan at a predetermined high speed according to the high-temperature signals.

### BACKGROUND OF THE INVENTION

1. Field of Invention

The present invention relates to system management architecture, and more particularly, to redundant fan control scheme in a computing system that includes multiple computation nodes.

2. Description of the Related Art

Generally, a regular computing system like personal computers includes several cooling fans configured on the same module of the heat-generation components such as CPUs. For example, a mother board in such system usually has several dedicated fans for its CPUs or graphic cards; these fans are basically controlled under a board-level management of the mother board.

However, in a multiple module system, system cooling fans are sometimes configured in another module that is different from the module with heat-generation components. Namely, the fans here are used to fulfill the cooling requirements of the whole system, instead of any specific mother board, CPU or graphic cards. Some of such systems use BMC (Baseboard Management Controller) in each of major modules (like mother boards or computation nodes) and the BMC usually use a standard interface (such as Ethernet and etc.) to communicate with different level of system management layers. To reach different level management layer and control a device from a top level layer, it is necessary to go through many software/firmware stacks, which sometimes doesn't reach a satisfied reliability. In a system that has extremely high temperature spots, especially for a HPC (High Performance Computing) system that includes multiple CPUs, fan control becomes a critical area.

Please refer to FIG. 1, which illustrates a prior art example of a computing system which has multi-module type hardware architecture. The system consists of a system management node 110, a system management network switch 120, multiple computation nodes 130, a system fan control module 140 and system fans 150. Some system might have specific I/O module and other functional modules, which are omitted in the drawing.

The system uses the BMC-type local management microcontroller to process local management tasks. Each of all major modules, including the system management node 110, the computation nodes 130 and the fan control module 140 has a dedicated BMC 112, 132 or 142. The system management node 110 is the top level layer for this type of management architecture. Each BMC is connected through the system management network switch 120 and the system management node 110 can collect system information of the whole computing system through the system management network switch 120. Each of the computation nodes 130 has one or more CPU configured thereon. Usually CPU is one of the highest temperature spot (hot spot) in a system. The independent fan control module 140 is managed by the system management node 110 to control the system fans 150 for the entire computing system.

In this type of system, the fan speed is usually controlled according to the temperature of system hot spots. Each local BMC 132 on the computation nodes 130 will monitor temperature sensor(s) of its local hot spot (CPU 134). The system management node needs to obtain those temperature data through the system management network switch 120. And then, based on the highest spot temperature, the system management node 110 will decide the speed of the system fans 150. The speed information will be collected by the system management node 110 first and sent to the fan control module 140 through the system management network switch 120.

During the normal operation this scheme works well. However, to achieve fan management, the temperature information and the fan speed information need to pass through many layers and software stacks. In FIG. 1, the temperature information needs to be collected from local BMCs 132 and then sent through the system management network, the system management network switch 120 and the system management node 110. The fan speed information will be collected by the system management node 110 first and sent through the system management network, the system management network switch 120, and then to the fan control module 140. Also, the information passes between different software/firmware domains, BMC firmware, and the host OS (Operating System) on the system management node 110 and a system management application program. In case that any part of the management architecture gets failure, the fan control loop will be broken. The system management node 110 might not be aware of the high temperature spot(s) incurred on one of the computation nodes 130, so the fan speed will not be set as a higher speed or the highest speed to force the temperature down in time. Consequently, the system either goes to an unstable state, shutdown or gets damaged.

### SUMMARY OF THE INVENTION

The present invention overcomes the problems of the prior art by providing a fan control architecture to solve various problems and limitations existing in the prior art. What the present invention provides is a redundant fan control scheme that improves system reliability through bypassing various software layers.

In an embodiment of the present invention, a fan control scheme is used to control system fan(s) on a computing system that has plural nodes. The fan control scheme includes: a management module that is configured respectively on each of the nodes, monitoring an operating temperature of hot spot(s) on each of the nodes respectively; a system management network that connects the management modules to send data of the operating temperatures of the hot spots on the nodes; a fan control module that includes another management module for controlling the system fan according to the operating temperatures; and redundant path(s) that sends high-temperature signal(s) from the node to the fan control module directly.

In another embodiment of the present invention, a redundant fan control scheme operates with a main fan control scheme to control system fan(s) on a computing system that has plural nodes. The main fan control scheme includes: a management module that is configured respectively on each of the nodes, monitoring an operating temperature of hot spot(s) on each of the nodes respectively; a system management network that connects the management modules to send data of the operating temperatures of the hot spots on the nodes; a fan control module that includes another management module for controlling the system fan according to the operating temperatures. And the redundant scheme includes redundant path(s) that connects between the node and the fan control module, thereby sending high-temperature signal(s) from the node to the fan control module directly.

The present invention will be apparent in its objects, features and advantages after reading the detailed description of the preferred embodiment thereof in reference to the accompanying drawings.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is an explanatory block diagram of a fan control scheme in the prior art.

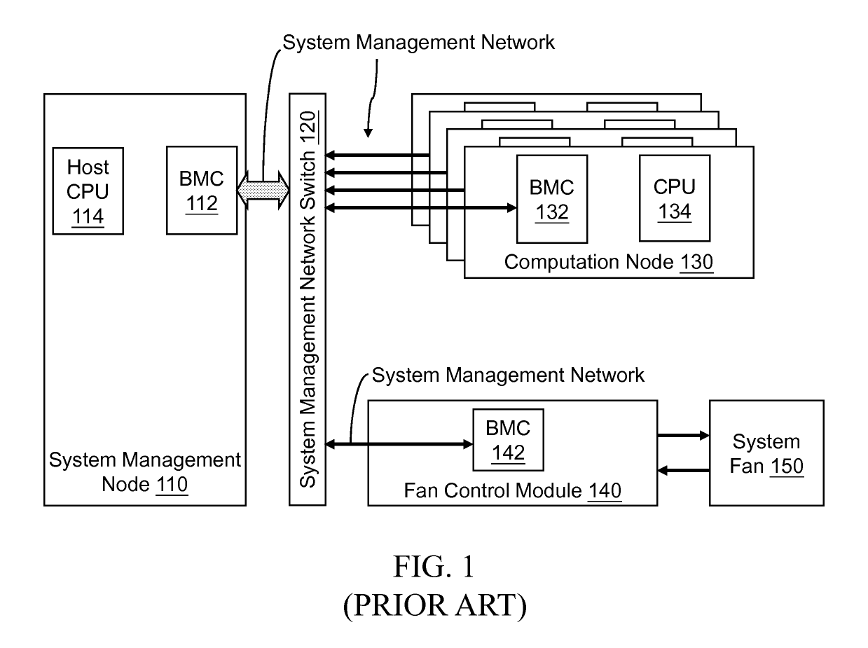

FIG. 2 is an explanatory block diagram of a fan control scheme according to an embodiment of the invention.

FIG. 3 is an explanatory block diagram of obtaining the high-temperature signal according to an embodiment of the invention.

FIG. 4 is an explanatory block diagram of obtaining the high-temperature signal according to another embodiment of the invention.

FIG. 5 is an explanatory block diagram of obtaining the high-temperature signal according to another embodiment of the invention.

FIG. 6 is an explanatory block diagram of a fan control module according to an embodiment of the invention.

### DETAILED DESCRIPTION OF THE INVENTION

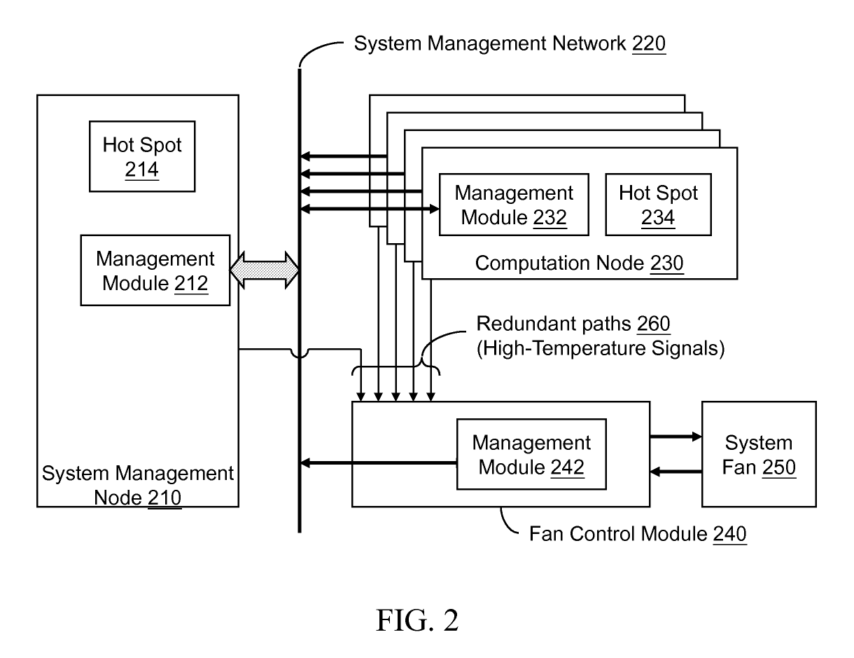

Please refer to FIG. 2. According to an embodiment of the present invention, an improved fan control scheme is applied to a computing system that has multiple nodes. As shown in the drawing, the computing system mainly includes multiple nodes (a system management node 210 and several computation nodes 230), a system management network 220, a fan control module 240 and one or more system fan(s) 250. For convenience of explanation, other components in the computing system are omitted.

Each of the nodes 210, 230 are usually implemented on mother boards. Each of the nodes 210, 230 includes one or more hot spot(s) 214, 234 that generates quite much heat, such as CPUs or graphic chips. Dedicated management modules 212, 232 and 242 configured respectively on each of the nodes 210, 230 are used to monitor an operating temperature of one or more hot spot on each of the nodes 210, 230 respectively. The management modules 212, 232 and 242 collect system information like component statuses and operation events, which may be realized by BMC (Baseboard Management Controller) or other management controllers/logics with remote/system control capabilities.

The system management network 220 connects the management modules 212, 232 and 242. Currently the system management network 220 follows specific standard protocols for internal and external communications, such as IPMI (Intelligent Platform Management Interface) specification. Those system informations collected by the management modules 232, 242 of the computation nodes 230 and the fan control module 240 may be sent back to the management module 212 of the system management node (so-called “head node”) 210 through the system management network 220.

Generally the fan control module 240 controls the system fan 250 according to the operating temperatures. Namely, the fan control module 250 sets and changes the speed of the system fan 250 if the operating temperatures of the hot spots 214, 234 raise high or become cooler. The system fan 250 is not used for or controlled by any specific hot spot or node. Through the system management network 220, the system fan 250 is mainly controlled by the system management node 210 and the fan control module 240.

One or more redundant path(s) 260, possibly realized by connection board(s), flexible circuit board or electrical cable(s), is connected between all the nodes 210, 230 and the fan control module 240. The redundant path 260 allows sending a high-temperature signal of the hot spot 214/234 from the nodes 210, 230 to the fan control module 240 directly. The high-temperature signal is basically a hardwired signal, indicating one or more of the hot spots 214, 234 reach a threshold high temperature. This threshold high temperature needs to be set as a close value lower than the maximum temperature of normal operation for the hot spots 214, 234. It is because when the hot spot temperature reaches the maximum temperature, the fan speed control will not be so critical for the system. By then the overheat function of the hot spot, such as the thermal trip function of a CPU, will be initiated.

In the normal operation and main fan control scheme, data of the operating temperatures of the hot spots 234 on the computation nodes 230 are collected by the management modules 232 and sent back to the management modules 212 of the system management node 210. The data of the operating temperature of the hot spot 214 on the system management node 210 are collected by its own management module 212. According to the collected data of the operating temperatures of the hot spots 214, 234, the system management node 210 sends commands through the system management network 220 to the fan control module 240 and process fan control tasks. The fan control module 240 may use the management module 242 to directly/indirectly control the speed of the system fan 250.

The normal fan control loop and main fan control scheme disclosed above need to pass through certain software/firmware stacks and some layers of communication paths. If any specific point of the loop is malfunctioned, the operating temperatures of the hot spots 214, 234 will rise too high and cause serious system damages. Therefore, when any of the operating temperatures of the hot spots 214, 234 reaches the threshold high temperature, the hardwired high-temperature signals will be sent from the nodes 210, 230, through the redundant paths 260 to the fan control module 240. And once the fan control module 240 receives any high-temperature signal, it will set the speed of the system fan 250 at a predetermined high speed, most likely the full speed of the system fan 250. Such redundant fan control scheme basically provides a redundant fan control loop that bypasses the software/firmware stacks and layers of the communication paths and facilitates direct control of the system fan in a critical system situation.

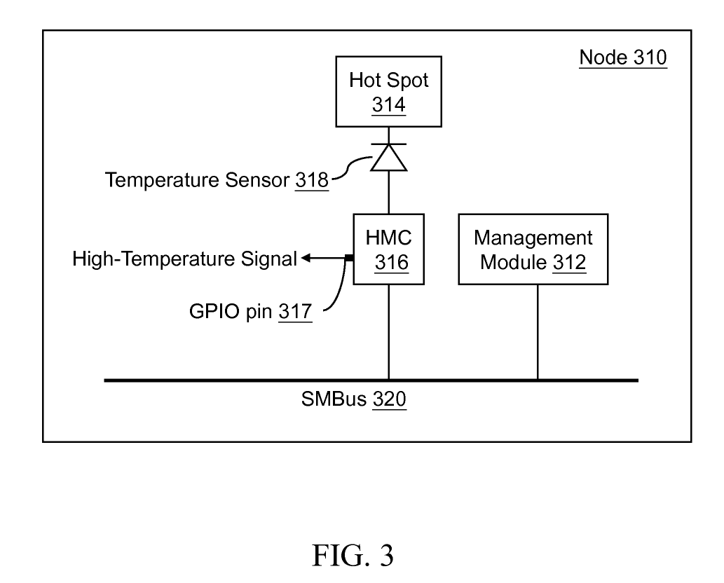

As to how to obtain the high-temperature signal, please refer to FIGS. 3, 4 and 5.

In FIG. 3, on any of the nodes 310, no matter the system management node (not shown) or the computation nodes (not shown), a temperature sensor 318 senses the operating temperature of a hot spot 314 and send signals constantly back to a hardware monitor controller (“HMC”) 316. Generally the hardware monitor controller 316 receives various types of system operating data like CPU temperature, fan speeds and etc., and then sends to the management module 312 through a SMBus (System Management Bus, compatible with IPMI Specifications) 320 (or other IPMI-compatible link) for remote/system management. In the present embodiment the hardware monitor controller 316 includes one or more GPIO (General Purpose Input/Output) pins. One GPIO pin 317 of the hardware monitor controller 316 is used to indicate if the operating temperature reaches the threshold high temperature. The hardware monitor controller 316 determines whether the operating temperature reaches the threshold high temperature, and then indicates it at the GPIO pin 317. Simply the logic high/low voltage level of the GPIO pin 317 will be enough to indicate the statuses of the high-temperature signal.

If the hardware monitor controller 316 has not enough GPIO pins for the high-temperature signal, a GPIO device (not shown) maybe use to connect with the SMBus 320 (or other IPMI-compatible link) and one GPIO pin (not shown) on the GPIO device will indicate the status of the GPIO pin 317 of the hardware monitor controller 316. The GPIO device may be a GPIO expander or I/O controller that has plural GPIO pins and allow multiple input/output on the same GPIO pin 317. If there are more than one hot spot configured on the same node, theoretically every hot spot should be provided with a corresponding high-temperature signal when its operating temperature reaches the threshold high temperature. Namely, each hot spot will have its dedicated temperature sensor and there will be a dedicated GPIO pin to indicate whether it reaches the threshold high temperature. Then, the usage of the GPIO device will become more significant.

For those hardware monitor controllers that do not have GPIO pins, or are not capable of determining if the operating temperature reaches the threshold high temperature, the management module may provide the function to set such interrupt-type indication.

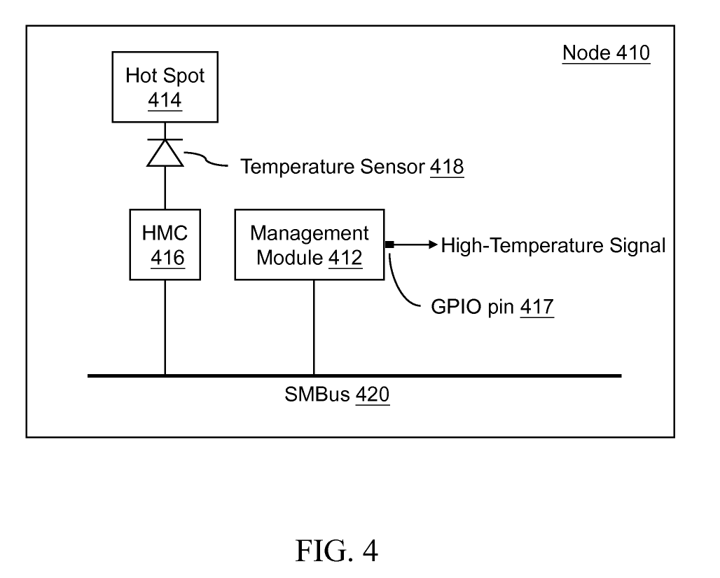

As shown in FIG. 4, on a node 410 a temperature sensor 418 senses the operating temperature of a hot spot 414 and send signals constantly back to a hardware monitor controller (“HMC”) 416. Generally the hardware monitor controller 416 will then sends the data of the operating temperature of the hot spot 414 with other system operating data to the management module 412 through a SMBus 420 for remote/system management. In the present embodiment management module 412 includes one or more GPIO pins. One GPIO pin 417 of management module 412 is used to indicate if the operating temperature reaches the threshold high temperature. The management module 412 determines whether the operating temperature of the hot spot 414 reaches the threshold high temperature, and then indicates it at the GPIO pin 417. Similarly, the logic high/low voltage level of the GPIO pin 417 will be enough to indicate the statuses of the high-temperature signal.

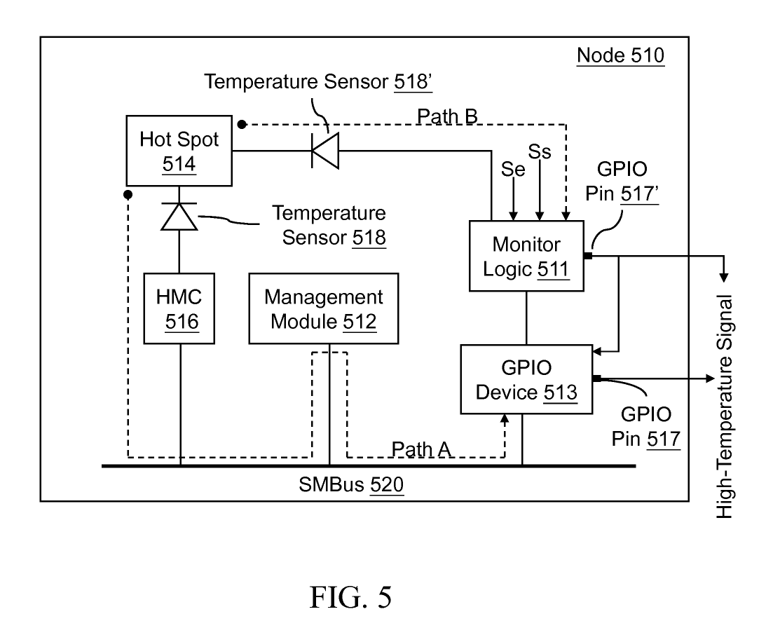

If the management module has not enough GPIO pins or there are more hot spots needed to be monitored, a GPIO device (not shown) can be use as mentioned above, as the path A shown in FIG. 5. Basically the above embodiments use the signal loop through the hardware monitor controller, or through both the hardware monitor controller and the management module. And the mentioned GPIO device is used to connect with the GPIO pin on the hardware monitor controller or the management module through an IPMI-compatible link, such as SMBus.

FIG. 5 also discloses another implementation to provide the high-temperature signal: the path B. Since usually the management architecture and the monitored information is fixed and limited in most of mother boards or systems, we can create a logic device to collect more system information by demand and facilitate improved customization capability for remote/system management. As shown in the drawing, on a node 510 a monitor logic 511 connects with a SMBus 520 with a GPIO device 513 connected in-between. Various status signal Ss and event signal Se are send to the monitor logic 511, as well as the data of the operating temperature of the hot spot 514. Here we can use an extra temperature sensor 518′ or simply use the same original temperature sensor 518 to sense the operating temperature of the hot spot 514.

The monitor logic 511 basically includes state monitors and event monitors (both not shown) that may be realized by flip-flops, logic gates and some circuits. The system information collected by the monitor logic 511 will be sent to the limited GPIO pins of the management module 512 through the GPIO device 513 and the SMBus 520. The situation of reaching the threshold high temperature may be processed as a system event and the GPIO pin 517′ will be latched at a specific status.

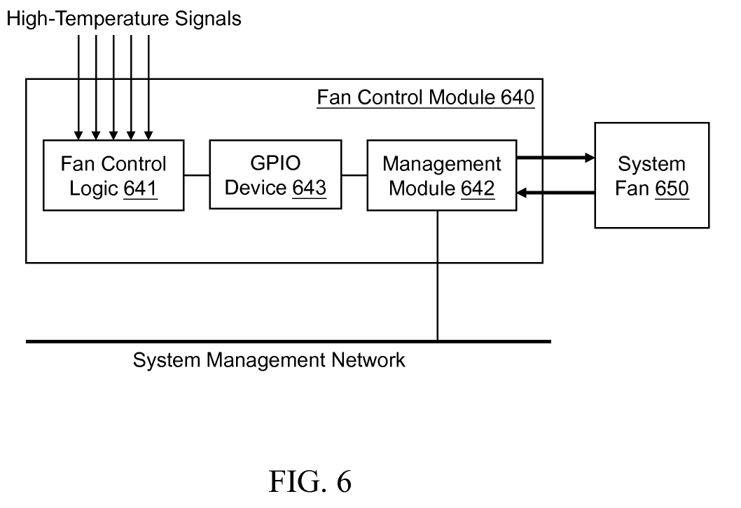

As to the control mechanism inside the fan control module, please refer to FIG. 6. In a fan control module 640, what included therein is a fan control logic 641, a management module 642 and a GPIO device 643. Similar to the monitor logic mentioned above, the fan control logic 641 basically includes state monitors and/or event monitors (both not shown) that may be realized by flip-flops, logic gates and some circuits. The definitions of the management module 642 and the GPIO device 643 are the same as above-mentioned. The high-temperature signals from the hot spots (not shown) of the nodes are first sent to the fan control logic 641. The fan control logic 641 may be designed to determine if any of the high-temperature signals indicates that any of the hot spots reaches the threshold high temperature in the beginning. And then send a single control signal to the management module 642 through the GPIO device 643. The management module 642 will send PWM (Pulse width modulation) type signals to set the system fan 650 at a predetermined high speed and cool down the hot spots. Sure a hardware monitor controller (not shown) may be connected between the management module 642 and the system fan 650. The hardware monitor controller may set the speed of the system fan 650 according to the commands of the management module 642.

If the high-temperature signals are designed to be handled by the management module 642, the fan control logic 641 may be omitted. All the high-temperature signals will be sent to the GPIO device 643 that can allow multiple inputs at the few limited GPIO pins of the management module 642. Namely, the high-temperature signal will be sent to the management module of the fan control module through the GPIO device.

If the high-temperature signals are designed to be handled first by the fan control logic 641, the GPIO device 643 is possible to be omitted. It is because the fan control logic 641 can first determine if any of the high-temperature signals indicates that any of the hot spots reaches the threshold high temperature and send only one indication signal to the management module 642. If the management module 642 can save a GPIO pin for the purpose, the GPIO device 643 will not be necessary any more. Namely, the high-temperature signal will be sent to the management module of the fan control module through the fan control logic.

Anyways, the fan control module will watch/monitor the high-temperature signal(s) and set the predetermined high speed based on the state of the high-temperature signal(s).

With the fan control scheme disclosed in the present invention, the fan control loop can bypass some software/firmware stack as well as some layer of communication path, such as the system management network, system management network switch, the management node host OS and application. Also, it helps to reduce fan speed information path as well. The redundant path will be much more reliable than the normal control path.

The following explains the summary of improvements:

In the high temperature situation, even if a normal fan control path (loop) has problem, the secondary path can control system fans. This help to reduce a chance to cause system level failure or problem.

The normal control path can control fan based on whole system information. This can be more effective way to control fan. But if the system has only the secondary path, it is hard to control efficiently.

The secondary path will add redundant control path with bypassing some layers. Required devices still can be a standard or off-the-shelf type device. This scheme does not require any special component to achieve this improvement.

There are two different paths to control system fans, but this scheme does not require avoiding race condition since the speed to be set will be the same speed between the two different initiators; no arbitration or similar scheme is required.

The preferred embodiments disclosed are only for illustrating the present invention, and not for giving any limitation to the scope of the present invention. It will be apparent to those skilled in this art that various modifications or changes can be made to the present invention without departing from the spirit and scope of this invention. Accordingly, all such modifications and changes also fall within the scope of protection of the appended claims

What is claimed is:

1. A fan control scheme for controlling at least one system fan on a computing system that has a plurality of nodes, the fan control scheme comprising:
a management module configured respectively on each of the nodes, monitoring an operating temperature of at least one hot spot on each of the nodes respectively;
a system management network connecting the management modules to send data of the operating temperatures of the hot spots on the nodes;
a fan control module including another management module for controlling the system fan according to the operating temperatures; and
at least one redundant path, sending at least one high-temperature signal from the node to the fan control module directly.

2. The fan control scheme of claim 1, wherein the fan control module sets the system fan at a predetermined high speed according to the high-temperature signal.

3. The fan control scheme of claim 1, wherein the high-temperature signal is a hardwired signal, indicating at least one of the hot spots reaches a threshold high temperature.

4. The fan control scheme of claim 3, wherein the threshold high temperature is set as a close value lower than the maximum temperature of normal operation for the hot spot.

5. The fan control scheme of claim 1, wherein one of the nodes is a system management node that mainly controls the fan control module through the system management network.

6. The fan control scheme of claim 1, wherein the high-temperature signal is provide from a GPIO (General Purpose Input/Output) pin of the management module or a hardware monitor controller configured on the node.

7. The fan control scheme of claim 6, wherein the high-temperature signal is provide from another GPIO pin of a GPIO device, the GPIO device connecting with the GPIO pin on the hardware monitor controller or the management module through a IPMI (Intelligent Platform Management Interface)-compatible link.

8. The fan control scheme of claim 1, wherein the data of the operating temperatures of the hot spot on the node is sent to a monitor logic and the high-temperature signal is provide from a GPIO pin of the monitor logic.

9. The fan control scheme of claim 1, wherein the fan control module further includes a GPIO device, the high-temperature signal being sent to the management module of the fan control module through the GPIO device.

10. The fan control scheme of claim 1, wherein the fan control module further includes a fan control logic, the high-temperature signal being sent to the management module of the fan control module through the fan control logic.

11. A redundant fan control scheme, operating with a main fan control scheme for controlling at least one system fan on a computing system that has a plurality of nodes, wherein the main fan control scheme comprising:
a management module configured respectively on each of the nodes, monitoring an operating temperature of at least one hot spot on each of the nodes respectively;
a system management network connecting the management modules to send data of the operating temperatures of the hot spots on the nodes; and
a fan control module including another management module for controlling the system fan according to the operating temperatures;
wherein the redundant scheme comprises at least one redundant path, the redundant path connecting between the node and the fan control module for sending at least one high-temperature signal from the node to the fan control module directly.

12. The redundant fan control scheme of claim 11, wherein the fan control module sets the system fan at a predetermined high speed according to the high-temperature signal.

13. The redundant fan control scheme of claim 11, wherein the high-temperature signal is a hardwired signal, indicating at least one of the hot spots reaches a threshold high temperature.

14. The redundant fan control scheme of claim 13, wherein the threshold high temperature is set as a close value lower than the maximum temperature of normal operation for the hot spot.

15. The redundant fan control scheme of claim 11, wherein the redundant path is realized by connection board, flexible circuit board or electrical cable.

16. The redundant fan control scheme of claim 11, wherein the high-temperature signal is provide from a GPIO (General Purpose Input/Output) pin of the management module or a hardware monitor controller configured on the node.

17. The redundant fan control scheme of claim 16, wherein the high-temperature signal is provide from another GPIO pin of a GPIO device, the GPIO device connecting with the GPIO pin on the hardware monitor controller or the management module through a IPMI (Intelligent Platform Management Interface)-compatible link.

18. The redundant fan control scheme of claim 11, wherein the data of the operating temperatures of the hot spot on the node is sent to a monitor logic and the high-temperature signal is provide from a GPIO pin of the monitor logic.

19. The redundant fan control scheme of claim 11, wherein the fan control module further includes a GPIO device, the high-temperature signal being sent to the management module of the fan control module through the GPIO device.

20. The redundant fan control scheme of claim 11, wherein the fan control module further includes a fan control logic, the high-temperature signal being sent to the management module of the fan control module through the fan control logic.
